(19) United States
(12) Patent Application Publication
(10) Pub. No.: US 2021/0239823 A1
(43) Pub. Date: Aug. 5, 2021

(54) TRIANGULATING A DEVICE'S LOCATION USING SHORT-RANGE WIRELESS SIGNALS

(71) Applicant: LENOVO (Singapore) PTE. LTD., New Tech Park (SG)

(72) Inventors: Russell Speight VanBlon, Raleigh, NC (US); Joshua Novak, Wake Forest, NC (US)

(21) Appl. No.: 16/781,853

(22) Filed: Feb. 4, 2020

(51) Int. Cl. G01S 13/46; H04W 12/00; H04W 4/02; H04W 4/029; H04W 4/33; H04W 4/80; H04W 64/00

(52) U.S. Cl. CPC G01S 13/46; H04W 12/00503; H04W 4/023; G01S 2013/468; H04W 4/33; H04W 4/80; H04W 64/003; H04W 4/029

(57) ABSTRACT

Apparatuses, methods, systems, and program products are disclosed for triangulating a device's location using short-range wireless signals. An apparatus includes a processor and a memory that stores code executable by the processor. The code is executable by the processor to receive a request to determine a location of a first device, determine locations of a plurality of second devices that are within a short range wireless communication proximity of the first device, triangulate the location of the first device based on the locations of the plurality of second devices, and report the triangulated location of the first device.

### FIELD

The subject matter disclosed herein relates to determining a device's location and more particularly relates to triangulating a device's location using short-range wireless signals.

### BACKGROUND

A device's precise location within a building cannot be determined using conventional location services. For instance, conventional location services can provide an address or GPS location, but fail to provide a pinpoint location for a device within a room, on a floor, or the like, which can be frustrating when trying to locate a more accurate location of the mobile device.

### BRIEF SUMMARY

Apparatuses, methods, systems, and program products are disclosed for triangulating a device's location using short-range wireless signals. An apparatus, in one embodiment, includes a processor and a memory that stores code executable by the processor. In certain embodiments, the code is executable by the processor to receive a request to determine a location of a first device, determine locations of a plurality of second devices that are within a short range wireless communication proximity of the first device, triangulate the location of the first device based on the locations of the plurality of second devices, and report the triangulated location of the first device.

A method for triangulating a device's location using short-range wireless signals, in one embodiment, includes receiving a request to determine a location of a first device, determining locations of a plurality of second devices that are within a short range wireless communication proximity of the first device, triangulating the location of the first device based on the locations of the plurality of second devices, and reporting the triangulated location of the first device.

A computer program product for triangulating a device's location using short-range wireless signals, in one embodiment, includes a computer readable storage medium having program instructions embodied therewith. In certain embodiments, the program instructions are executable by a processor to cause the processor to receive a request to determine a location of a first device, determine locations of a plurality of second devices that are within a short range wireless communication proximity of the first device, triangulate the location of the first device based on the locations of the plurality of second devices, and report the triangulated location of the first device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for triangulating a device's location using short-range wireless signals;

FIG. 2 is a schematic block diagram illustrating one embodiment of an apparatus for triangulating a device's location using short-range wireless signals;

FIG. 3 is a schematic block diagram illustrating one embodiment of an example system for triangulating a device's location using short-range wireless signals;

FIG. 4 is a schematic flow chart diagram illustrating one embodiment of a method for triangulating a device's location using short-range wireless signals; and

FIG. 5 is a schematic flow chart diagram illustrating one embodiment of another method for triangulating a device's location using short-range wireless signals.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in one embodiment, includes a processor and a memory that stores code executable by the processor. In certain embodiments, the code is executable by the processor to receive a request to determine a location of a first device, determine locations of a plurality of second devices that are within a short range wireless communication proximity of the first device, triangulate the location of the first device based on the locations of the plurality of second devices, and report the triangulated location of the first device.

In one embodiment, the plurality of second devices comprise stationary devices that have not moved a threshold distance for a predetermined period of time. In certain embodiments, the request to determine the location of the first device is received in response to movement of the first device. In further embodiments, movement of the first device is detected by at least one of the plurality of second devices and, in response to the detected movement, the plurality of second devices are used to triangulate the first device's location.

In one embodiment, at least a portion of the plurality of second devices comprise Internet of Things (“IoT”) devices that are communicatively connected to each other over a network. In some embodiments, the plurality of second devices are configured to detect short range wireless communication signals that the first device transmits. In certain embodiments, the code is executable by the processor to analyze information associated with the short range wireless communication signals detected at each of the plurality of second devices to triangulate the first device's location.

In one embodiment, the code is executable by the processor to report the triangulated location of the first device by storing and/or broadcasting the first device's location, identifying information for the first device, and a timestamp indicating when the first device's location was determined. In certain embodiments, the triangulated location comprises a location that is relative to the locations of the plurality of second devices.

In various embodiments, the code is executable by the processor to translate the triangulated location into a physical location within a building based on the locations of the plurality of second devices. In one embodiment, the plurality of second devices comprise at least three second devices. In some embodiments, the first device is designated as a non-stationary device.

A method for triangulating a device's location using short-range wireless signals, in one embodiment, includes receiving a request to determine a location of a first device, determining locations of a plurality of second devices that are within a short range wireless communication proximity of the first device, triangulating the location of the first device based on the locations of the plurality of second devices, and reporting the triangulated location of the first device.

In one embodiment, the plurality of second devices comprise stationary devices that have not moved a threshold distance for a predetermined period of time. In certain embodiments, the request to determine the location of the first device is received in response to movement of the first device. In one embodiment, movement of the first device is detected by at least one of the plurality of second devices and, in response to the detected movement, the plurality of second devices are used to triangulate the first device's location.

In one embodiment, at least a portion of the plurality of second devices comprise Internet of Things (“IoT”) devices that are communicatively connected to each other over a network. In some embodiments, the method includes reporting the triangulated location of the first device by storing and/or broadcasting the first device's location, identifying information for the first device, and a timestamp indicating when the first device's location was determined. In one embodiment, the method includes translating the triangulated location into a physical location within a building based on the locations of the plurality of second devices.

A computer program product for triangulating a device's location using short-range wireless signals, in one embodiment, includes a computer readable storage medium having program instructions embodied therewith. In certain embodiments, the program instructions are executable by a processor to cause the processor to receive a request to determine a location of a first device, determine locations of a plurality of second devices that are within a short range wireless communication proximity of the first device, triangulate the location of the first device based on the locations of the plurality of second devices, and report the triangulated location of the first device.

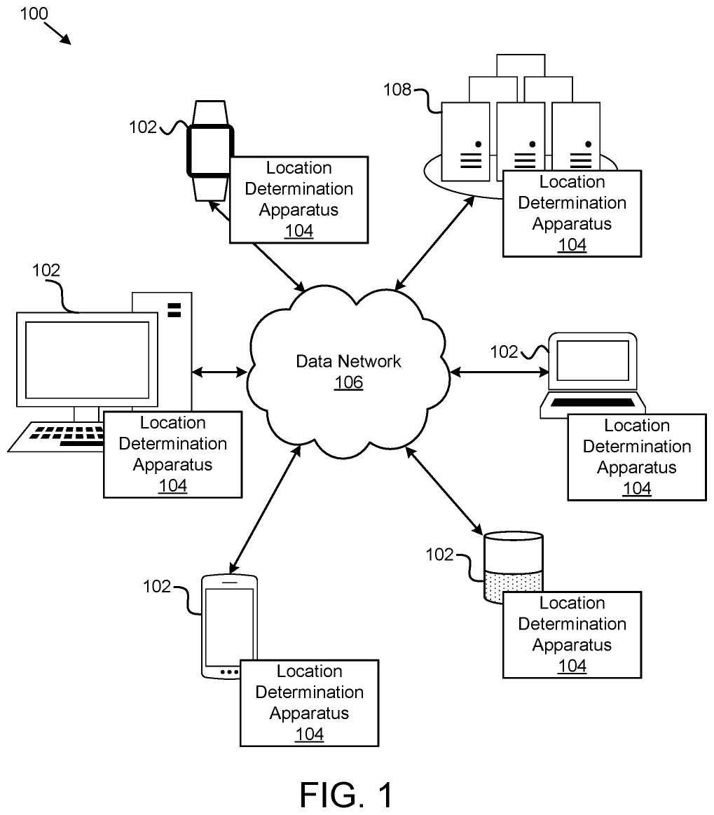

FIG. 1 is a schematic block diagram illustrating one embodiment of a system 100 for triangulating a device's location using short-range wireless signals. In one embodiment, the system 100 includes one or more information handling devices 102, one or more location determination apparatuses 104, one or more data networks 106, and one or more servers 108. In certain embodiments, even though a specific number of information handling devices 102, location determination apparatuses 104, data networks 106, and servers 108 are depicted in FIG. 1, one of skill in the art will recognize, in light of this disclosure, that any number of information handling devices 102, location determination apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), an Internet of Things (“IoT”) device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In certain embodiments, the information handling devices 102 may comprise stationary and mobile devices. Stationary devices, as used herein, may include devices that have not moved a predetermined or threshold distance for a predetermined or threshold period of time. For example, stationary devices may include smart IoT devices such as network connected refrigerators, microwaves, dishwashers, ovens, televisions, lights, light switches, outlets, doorbells, garage door openers, water heaters, furnaces, thermostats, ceiling fans, streaming boxes, desktop computers, security systems, audio systems and soundbars, fireplaces, lamps, couches, sofas, washers, dryers, faucets, sprinkler control boxes, and/or the like. The predetermined period of time for not moving may be on the order of days, weeks, months, or years. An amount of movement of the devices may be determined based on data captured from sensors such as accelerometers, gyroscopes, motion sensors, location/GPS sensors, proximity sensors, light sensors, and/or the like.

Mobile devices, on the other hand, may refer to nonstationary devices that frequently move or do not stay in a particular location for a sustained period of time. Examples of such devices may include mobile phones, remote controls, gaming controllers, watches, wallets, purses, bags, and/or the like. Both stationary and mobile devices may be communicatively coupled to a data network 106, described below, and/or directly to one another over a short-range wireless communication protocol such as Wi-Fi, Bluetooth®, near-field communication, Z-Wave, Zigbee, and/or the like, and may include sensors for detecting wireless signals emitted or transmitted from the devices.

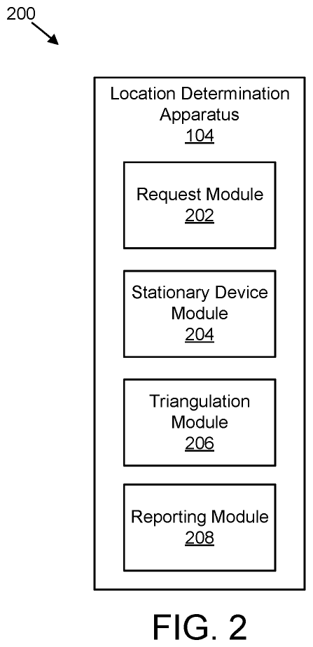

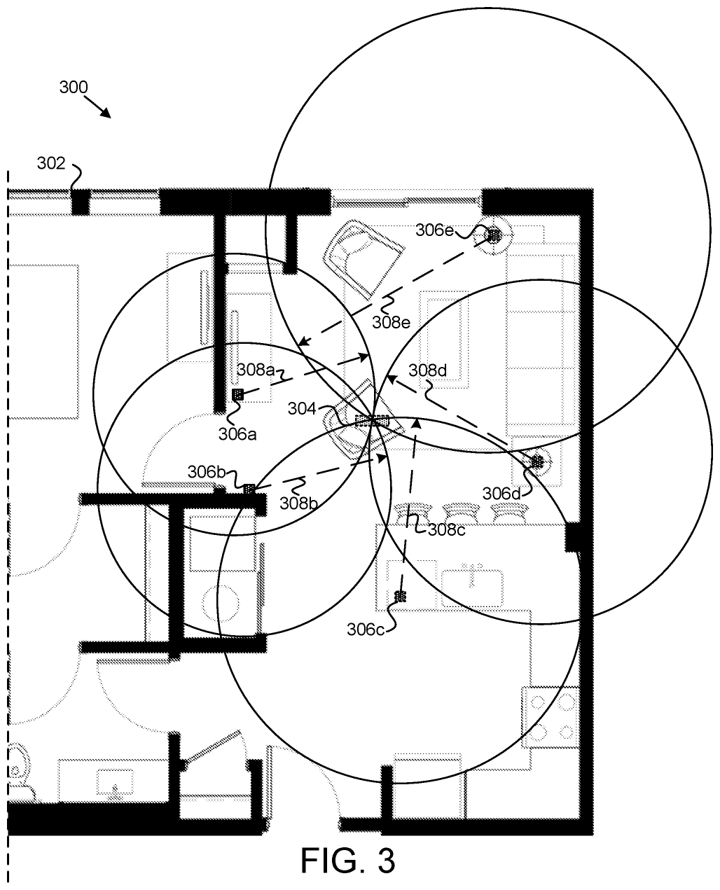

In one embodiment, the location determination apparatus 104 is configured to receive a request to determine a location of a first device, determine locations of a plurality of second devices that are within a short range wireless communication proximity of the first device, triangulate the location of the first device based on the locations of the plurality of second devices, and report the triangulated location of the first device. The location determination apparatus 104, including its various sub-modules, may be located on one or more information handling devices 102 in the system 100, one or more servers 108, one or more network devices, and/or the like. The location determination apparatus 104 is described in more detail below with reference to FIGS. 2 and 3.

The location determination apparatus 104, in one embodiment, improves upon conventional triangulation systems by providing a more accurate location for a mobile device, e.g., a room within a building or within inches or feet of a reference point instead of a broader location such as an address or house number. This may assist users in finding or locating items that are moved and can often be misplaced such as remote controls for set top boxes or televisions, wallets or keys that include wireless signal emitting capabilities or devices (e.g., a Tile® device), and/or the like. The location determination apparatus 104 may pinpoint an exact, or near exact location for the misplaced device using a plurality of stationary devices that are within a proximity, e.g., a short-range wireless signal sensing distance of the misplaced device in order to triangulate the misplaced device's location.

In various embodiments, the location determination apparatus 104 may be embodied as an application, e.g., a mobile application, a website, and/or a hardware appliance that can be installed or deployed on an information handling device 102, on a server 108, on a user's mobile device, on a display, or elsewhere on the data network 106. In certain embodiments, the location determination apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the location determination apparatus 104 may include a power interface, a wired and/or wireless network interface, a graphical interface that attaches to a display, and/or a semiconductor integrated circuit device as described below, configured to perform the functions described herein with regard to the location determination apparatus 104.

The location determination apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the location determination apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the location determination apparatus 104.

The semiconductor integrated circuit device or other hardware appliance of the location determination apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the location determination apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102.

FIG. 2 is a schematic block diagram illustrating one embodiment of an apparatus 200 for triangulating a device's location using short-range wireless signals. In one embodiment, the apparatus 200 includes an instance of a location determination apparatus 104. In one embodiment, the location determination apparatus 104 includes one or more of a request module 202, a stationary device module 204, a triangulation module 206, and a reporting module 208, which are described in more detail below.

In one embodiment, the request module 202 is configured to receive a request to determine a location of a first device. The request module 202, in such an embodiment, may be located on a central server, a network device (e.g., a network router), on a user's device, or on one or more devices connected to the data network 106. A user, for instance, may manually request the location of a device, such as a remote control, by submitting the request using a mobile application, a web page, and/or another interface to the location determination apparatus. In such an embodiment, the interface may provide a listing of known devices, recently detected devices, and/or the like, which the user may select from to see the device's last known location and/or to trigger an update to the device's location. Furthermore, a user may manually enter device identification information via the interface to determine whether the device has been detected, the last time that the device was detected, and/or the last known location of the device.

In certain embodiments, the request module 202 receives a request to determine a device's location in response to detecting movement of the first device. For example, when a first device such as a smart phone or remote control is moved, one or more devices on the data network 106, e.g., one or more stationary IoT devices may detect the movement, e.g., based on detecting a change in angle or direction of wireless signals detected from the first device and may report or signal the movement, e.g., to the request module 202, which triggers a request to determine or update the movement of the first device. In certain embodiments, the first device detects its own movement, e.g., based on accelerometer data, and sends a request to determine the first device's new location.

In certain embodiments, the request module 202 may initiate a timer or wait a period of time after the first device is done moving to trigger the request to determine or update the location of the first device. In this manner, the request module 202 doesn't trigger multiple different requests to determine the first device's location while the device is moving.

In one embodiment, the stationary device module 204 is configured to determine locations of a plurality of second devices that are within a short range wireless communication proximity of the first device. As described above, the plurality of second devices may include stationary devices that have not moved a threshold distance for a predetermined period of time, e.g., smart televisions, kitchen appliances, thermostats, smart outlets, smart lights, smart doorbells, etc.

The stationary device module 204, in response to the request module 202 receiving or triggering a request to determine a first device's location, determines which stationary devices on the data network 106 detect the first device, e.g., are within a proximity or distance of the first device to be able to detect wireless signals that the first device emits or transmits such as cellular signals, Wi-Fi signals, Bluetooth® signals, NFC signals, and/or the like.

In response to determining the stationary devices, the stationary device module 204 determines the locations of the stationary devices, e.g., relative to a network router, a physical location in a building (e.g., in the kitchen, against the north wall in the kitchen, etc.), a GPS coordinate, a location relative to another point of interest (e.g., another device), and/or the like. The stationary device module 204 may prompt the user to confirm whether a device is a stationary device, e.g., when the device is first installed or connected to the data network, and if so, provide the location of the stationary device within the building, home, office, etc., which may be used to translate the first device's triangulated location to a physical location, as described below. The stationary device module 204 may determine identifiers for the determined stationary devices to pass on to the triangulation module 206 for triangulating the first device's location based on the locations of the determined stationary devices.

In certain embodiments, the stationary device module 206 determines the locations of at least three stationary devices that can be used to triangulate the location of the first device. In some embodiments, at least a portion of the plurality of second devices comprise Internet of Things (“IoT”) devices that are communicatively connected to each other over a network. As used herein, an IoT device may refer to consumer “smart home” devices that are connected to a data network 106 such as appliances, lighting fixtures, thermostats, security systems, televisions, cameras, outlets, doorbells, garage door openers, etc., and which can be controlled via devices that are connected to the same data network 106 such as smart phones and smart speakers.

In some embodiments, the first device is designated, e.g., by a user, as a non-stationary device, a mobile device, and/or the like to indicate to stationary devices that the first device is not a stationary device and therefore its location should be determined, monitored, and updated while it is connected to the data network, while it is within a proximity of one or more stationary devices, when it moves, and/or the like.

In one embodiment, the triangulation module 206 is configured to triangulate the location of the first device based on the locations of the stationary devices. As used herein, triangulation may refer to determining the location of a signal emitting device by measuring the radial distance and/or the direction of the received signal from two or more different stationary devices.

Thus, as it relates to the subject matter described herein, the triangulation module 206 may analyze information associated with the short range wireless communication signals that are detected at each of the plurality of second devices to triangulate the first device's location. For instance, a stationary device may determine the distance to the first device by pinging the first device and determining the amount of time it takes to receive a signal back from the first device. Furthermore, certain stationary devices may have a directional antenna that can be used to pinpoint the location of the first device.

In one embodiment, at least one of the stationary devices detects movement of the first device and signals the request module 202 to trigger a request to determine the location of the first device in response to the first device's movement using a plurality of stationary devices to triangulate the first device's location. The movement may be detected by detecting, at the stationary devices, a change in the angle, direction, strength, or the like of the wireless signals transmitted from the first device.

In one embodiment, the triangulation module 206 translates the determined triangulated position for the first device into a physical location within a building, home, office, or the like based on the locations of the stationary devices that are used to triangulate the first device's location. For instance, the stationary devices may have a designated location (e.g., a user-defined or designated location) such as a room (e.g., a room number, a room name, and/or the like), a position in a room, and/or the like, which may correspond to a floorplan, a blueprint, and/or the like for the building/home/office where the stationary devices are located. The triangulation module 206 may translate, convert, map, or the like the triangulated location to a physical location, e.g., a room or a location relative to the stationary devices, e.g., ten feet left or south of the fridge, and/or the like.

In one embodiment, the reporting module 208 is configured to report the triangulated location of the first device. In certain embodiments, the reporting module 208 reports the triangulated location of the first device by storing and/or broadcasting the first device's location (triangulated and/or physical), identifying information for the first device (e.g., a device identifier or name), a timestamp indicating the last time the first device's location was determined, and/or the like.

The reporting module 208 may broadcast the first device's location to stationary devices and/or other mobile devices. In further embodiments, the reporting module 208 stores the first device's location in an accessible storage location, e.g., a storage location on a local network, in the cloud, and/or the like. In this manner, if the user loses a mobile or nonstationary device, the user can access the device's last known location within the house/office/room, etc., which has been determined with enough accuracy to give the user a near pinpoint location.

In certain embodiments, the reporting module 208 presents a graphical floorplan or blueprint of the room or building where the first device is located and visually highlights where the first device is on the floorplan, such as using a graphical pin or other graphical element. In certain embodiments, the floorplan may include other objects such as furniture (which the user may input or may be dynamically determined using images taken from cameras on the stationary devices) so that the user can see where the first device is located relative to other objects in the room, e.g., under the couch.

FIG. 3 depicts an example system 300 for triangulating a device's location using short-range wireless signals. In one embodiment, the system 300 includes a building/room/floorplan 302 for a home or office or other building. In certain embodiments, the system 300 includes a first device (mobile or non-stationary device) 304, such as a remote control, and a plurality of stationary devices 306a-e (collectively 306).

The plurality of stationary devices may include set-top boxes (e.g., streaming devices such as a Roku®), kitchen appliances, light fixtures, thermostats, televisions, and/or the like. The stationary devices 306 may detect wireless communication signals that the first device 304 transmits such as short-range wireless signals like Bluetooth®, Wi-Fi, or the like.

In some embodiments, in response to detecting the first device 304 move, the request module 202 may receive or trigger a request to determine the device's location. The stationary device module 204 may determine locations of stationary devices 306 that are located within a signal sensing proximity of the first device 304. Based on the signal information received at the stationary devices 306 from the first device 304, the triangulation module 206 triangulates the location of the first device 304 within the room, relative to stationary device 306 or other point of interest, and/or the like.

For instance, the triangulation module 206 may ping the first device 304 from each of the stationary devices 306 to determine the distances 308a-308e between the first device 304 and each of the stationary devices 306 in order to triangulate the first device's location relative to the stationary devices 306. Accordingly, the reporting module 208 broadcasts and/or stores the first device's location so that the user can locate the first device 304, even if it is located under a chair, within the cushions of a couch, or the like.

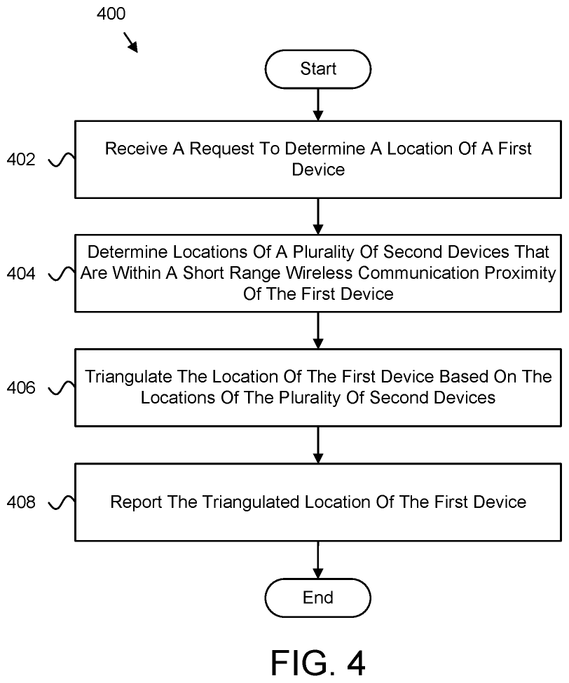

FIG. 4 is a schematic flow chart diagram illustrating one embodiment of a method 400 for triangulating a device's location using short-range wireless signals. In one embodiment, the method 400 begins and receives 402 a request to determine a location of a first device. In certain embodiments, the method 400 determines 404 locations of a plurality of second devices that are within a short range wireless communication proximity of the first device.

In further embodiments, the method 400 triangulates 406 the location of the first device based on the locations of the plurality of second devices. In certain embodiments, the method 400 reports 408 the triangulated location of the first device, and the method 400 ends. In one embodiment, the request module 202, the stationary device module 204, the triangulation module 206, and the reporting module 208 perform the various steps of the method 400.

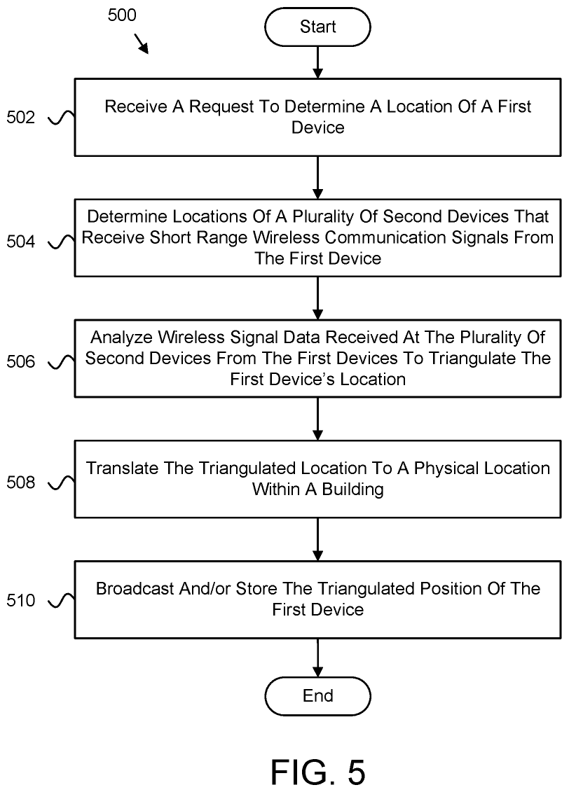

FIG. 5 is a schematic flow chart diagram illustrating one embodiment of another method 500 for triangulating a device's location using short-range wireless signals. In one embodiment, the method 500 begins and receives 502 a request to determine a location of a first device. In further embodiments, the method 500 determines 504 locations of a plurality of second devices that receive short range wireless communication signals from the first device.

In one embodiment, the method 500 analyzes 506 wireless signal data that is received at the plurality of second devices from the first devices to triangulate the first device's location. In some embodiments, the method 500 translates 508 the triangulated location to a physical location within a building. The method 500, in further embodiments, broadcasts 510 and/or stores the triangulated position of the first device, and the method 500 ends. In one embodiment, the request module 202, the stationary device module 204, the triangulation module 206, and the reporting module 208 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
receive a request to determine a location of a first device;
determine locations of a plurality of second devices that are within a short range wireless communication proximity of the first device;
triangulate the location of the first device based on the locations of the plurality of second devices; and
report the triangulated location of the first device.

2. The apparatus of claim 1, wherein the plurality of second devices comprise stationary devices that have not moved a threshold distance for a predetermined period of time.

3. The apparatus of claim 1, wherein the request to determine the location of the first device is received in response to movement of the first device.

4. The apparatus of claim 3, wherein movement of the first device is detected by at least one of the plurality of second devices and, in response to the detected movement, the plurality of second devices are used to triangulate the first device's location.

5. The apparatus of claim 1, wherein at least a portion of the plurality of second devices comprise Internet of Things (“IoT”) devices that are communicatively connected to each other over a network.

6. The apparatus of claim 1, wherein the plurality of second devices are configured to detect short range wireless communication signals that the first device transmits.

7. The apparatus of claim 6, wherein the code is executable by the processor to analyze information associated with the short range wireless communication signals detected at each of the plurality of second devices to triangulate the first device's location.

8. The apparatus of claim 1, wherein the code is executable by the processor to report the triangulated location of the first device by storing and/or broadcasting the first device's location, identifying information for the first device, and a timestamp indicating when the first device's location was determined.

9. The apparatus of claim 1, wherein the triangulated location comprises a location that is relative to the locations of the plurality of second devices.

10. The apparatus of claim 1, wherein the code is executable by the processor to translate the triangulated location into a physical location within a building based on the locations of the plurality of second devices.

11. The apparatus of claim 1, wherein the plurality of second devices comprise at least three second devices.

12. The apparatus of claim 1, wherein the first device is designated as a non-stationary device.

13. A method, comprising:
receiving, by a processor, a request to determine a location of a first device;
determining locations of a plurality of second devices that are within a short range wireless communication proximity of the first device;
triangulating the location of the first device based on the locations of the plurality of second devices; and
reporting the triangulated location of the first device.

14. The method of claim 13, wherein the plurality of second devices comprise stationary devices that have not moved a threshold distance for a predetermined period of time.

15. The method of claim 13, wherein the request to determine the location of the first device is received in response to movement of the first device.

16. The method of claim 15, wherein movement of the first device is detected by at least one of the plurality of second devices and, in response to the detected movement, the plurality of second devices are used to triangulate the first device's location.

17. The method of claim 13, wherein at least a portion of the plurality of second devices comprise Internet of Things (“IoT”) devices that are communicatively connected to each other over a network.

18. The method of claim 13, further comprising reporting the triangulated location of the first device by storing and/or broadcasting the first device's location, identifying information for the first device, and a timestamp indicating when the first device's location was determined.

19. The method of claim 13, further comprising translating the triangulated location into a physical location within a building based on the locations of the plurality of second devices.

20. A computer program product, comprising a computer readable storage medium having program instructions embodied therewith, the program instructions executable by a processor to cause the processor to:
receive a request to determine a location of a first device;
determine locations of a plurality of second devices that are within a short range wireless communication proximity of the first device;
triangulate the location of the first device based on the locations of the plurality of second devices; and
report the triangulated location of the first device.
